(19) United States
(12) Patent Application Publication
(10) Pub. No.: US 2013/0179830 A1
(43) Pub. Date: Jul. 11, 2013

(54) GRAPHICAL USER INTERFACE, DISPLAY APPARATUS AND CONTROL METHOD THEREOF

(71) Applicant: Samsung Electronics Co., Ltd., Suwon-si (KR)

(72) Inventors: Dong-heon LEE, Seoul (KR); Yoo-tai KIM, Yongin-si (KR); Ji-woo SUH, Seoul (KR); Yong-jin SO, Seoul (KR); Seung-dong YU, Hwaseong-si (KR)

(73) Assignee: SAMSUNG ELECTRONICS CO., LTD., Suwon-si (KR)

(21) Appl. No.: 13/737,269

(22) Filed: Jan. 9, 2013

(30) Foreign Application Priority Data
Jan. 9, 2012 (KR) 10-2012-0002519

(51) Int. Cl. G06F 3/0484

(52) U.S. Cl. CPC G06F 3/04845
USPC 715/784

(57) ABSTRACT

A display apparatus includes a display unit; an image processor which generates a user interface (UI) screen and displays the UI screen on the display unit; and a controller which controls the image processor to display on the display unit the UI screen comprising an object of a first group of objects, to reduce the size of the UI screen displayed on the display unit in response to a first, and to display the UI screen comprising an object of a second group in response to a command to scroll the UI screen.

### CROSS-REFERENCE TO RELATED APPLICATION

This application claims priority from Korean Patent Application No. 10-2012-0002519, filed on Jan. 9, 2012 in the Korean Intellectual Property Office, the disclosure of which is incorporated herein by reference.

### BACKGROUND

1. Field

Apparatuses and methods consistent with the exemplary embodiments relate to a graphical user interface, a display apparatus and a control method thereof which displays an image of various objects, and more particularly, to a graphical user interface, a display apparatus and a control method thereof which controls a display method of an object image corresponding to a user's manipulation.

2. Description of the Related Art

A display unit of a display apparatus has such size and resolution to display and support an image. Due to such features, the display unit may not display thereon an entire image of a predetermined object. For example, if an object includes a plurality of pages, only one of which may be displayed at a time on the display unit. In this case, the remaining pages other than the displayed page are not displayed on the display unit and are hidden. The display apparatus may then provide a scrollable object so that the remaining pages of the object which have not been displayed may be displayed upon scrolling.

For example, a user may scroll the object through a remote controller, etc., and accordingly the display apparatus sequentially or by stages displays a hidden area of the object according to the scrolling operation.

### SUMMARY

According to an aspect of an exemplary embodiment, there is provided a display apparatus including: a display unit; an image processor which generates a user interface (UI) screen and displays the UI screen on the display unit; and a controller which controls the image processor to display on the display unit the UI screen including an object of a first group of objects, reduce the size of the UI screen in response to a first command, and display the UI screen including an object of a second group in response to a command to scroll the UI screen.

The controller may control the image processor to display the UI screen including the object of the first group and at least a part of the object of the second group in response to the first command.

The UI screen including the object of the first group and the UI screen including the object of the second group may be reduced in size at a same rate.

In response to a command to discontinue scrolling the UI screen, the UI screen including the object of the second group may be enlarged and displayed in the same size as the original size of the UI screen including the object of the first group.

The command to discontinue scrolling the UI screen may include at least one of a user input to discontinue scrolling the UI screen, absence of a user input for predetermined time after the first command is received, and a command selecting one of the objects in the UI screen.

The first command may include a user selection of an area of the UI screen in which an object is not displayed, and the command to scroll the UI screen may include a user input indicating a scrolling direction.

The image processor may display a plurality of UI screens, and the controller may independently scroll the plurality of UI screens.

According to an aspect of another exemplary embodiment, there is provided a control method of a display apparatus including: displaying a UI screen including an object; reducing the size of the UI screen in response to a first command; and displaying the UI screen including an object of a second group in response to a command to scroll the UI screen.

The reducing the size of the UI screen may include displaying the UI screen including a the object of the first group and at least a part of the object of the second group in response to the first command.

The UI screen including the object of the first group and the UI screen including the object of the second group may be reduced in size at a same rate.

In response to a command to discontinue scrolling, the UI screen including the object of the second group may be enlarged and displayed in the same size as the original size of the UI screen including the object of the first group.

The command to discontinue scrolling the UI screen may be a user input to discontinue scrolling the UI screen, absence of a user input for a predetermined time after the first command, or a command selecting one of the objects in the UI screen.

The first command may include a user selection of an area of the UI screen in which an object is not displayed, and the command to scroll the UI screen may include a user input indicating a scrolling direction.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 illustrates an example of a display system according to an exemplary embodiment;

FIG. 2 is a block diagram of a display apparatus of the display system in FIG. 1 according to an exemplary embodiment;

FIG. 3 illustrates an example of scrolling an object that is displayed on a display unit of the display apparatus in FIG. 2 according to an exemplary embodiment;

FIG. 4 illustrates an example of an object image at an initial stage in the display apparatus in FIG. 2 according to an exemplary embodiment;

FIG. 5 illustrates an example of an object image that is reduced corresponding to a preset event from the image in FIG. 4 according to an exemplary embodiment;

FIG. 6 illustrates an example of reducing and displaying an object image in a different method than in FIG. 5 according to an exemplary embodiment;

FIG. 7 is a control flowchart of a control method of the display apparatus in FIG. 2 according to an exemplary embodiment;

FIG. 8 illustrates an example of a user interface (UI) screen at an initial stage in a display apparatus according to another exemplary embodiment;

FIG. 9 illustrates an example of a UI screen that is reduced and displayed from the state in FIG. 8 according to an exemplary embodiment;

FIG. 10 illustrates an example of a UI screen that is scrolled from the state in FIG. 9 according to an exemplary embodiment; and

FIG. 11 illustrates an example of a UI screen that is restored to its original size from the state in FIG. 10 according to an exemplary embodiment.

### DETAILED DESCRIPTION OF EXEMPLARY EMBODIMENTS

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout.

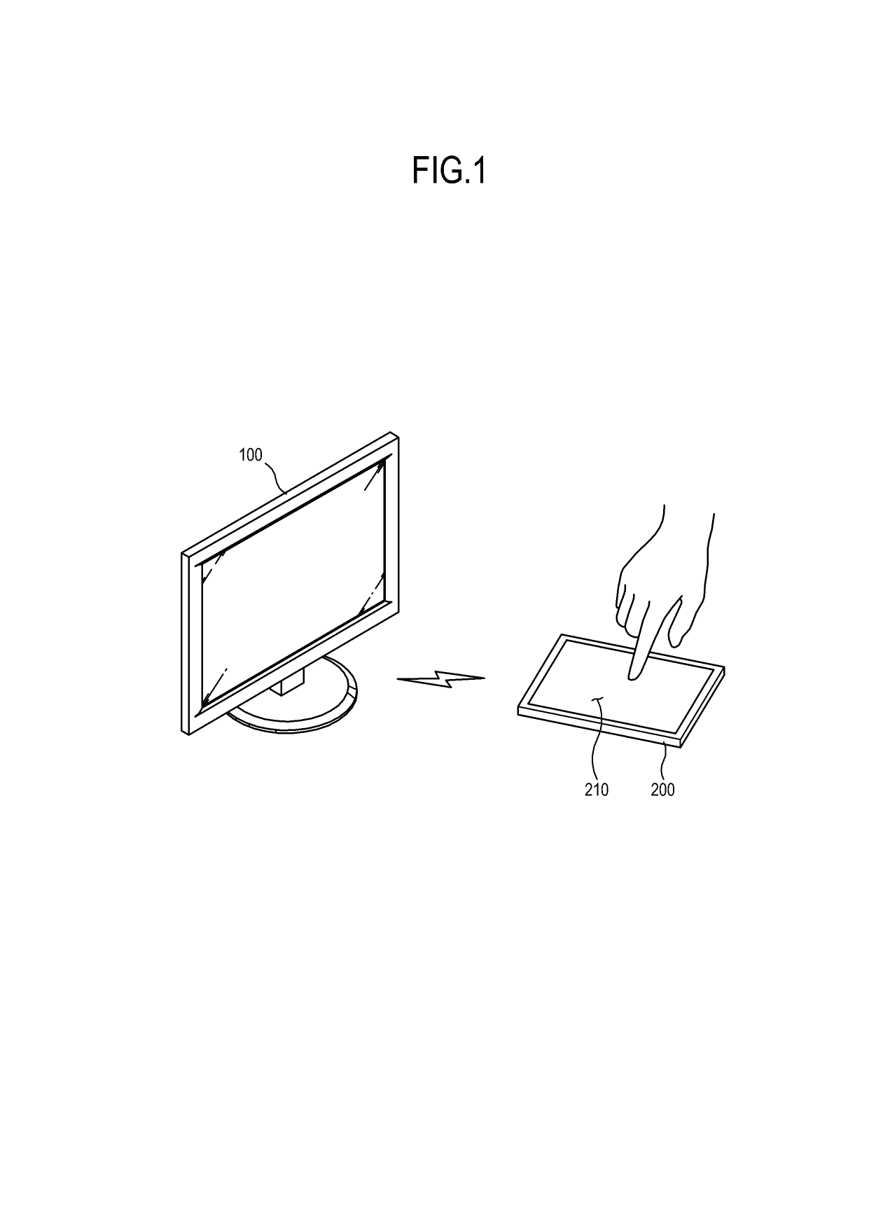

FIG. 1 illustrates an example of a display system according to an exemplary embodiment.

As shown in FIG. 1, the display system according to exemplary embodiment includes a display apparatus 100 which processes an image signal according to a preset process and displays the image signal as an image on a screen; and an input device 200 which generates and transmits a preset command, data, information and/or signal to the display apparatus 100 to remotely control an operation of the display apparatus 100.

The display apparatus 100 may be a television (TV) which displays an image based on an image signal, image data and/or image information that is supplied by an external image supply source (not shown) or stored in memory of the display apparatus 100, and the input device 200 may be a remote controller.

However, the inventive concept may also apply to different configurations of the display apparatus 100 and the input device 200. For example, the display apparatus 100 may be a monitor connected to a computer, etc., and the input device 200 may be a touchpad, a touchscreen integrated with a monitor, a mouse, a keyboard, or other device which communicates with the display apparatus 100 and is manipulated by a user. That is, exemplary embodiments which will be described hereinafter are exemplary embodiments which are variants depending on an embodiment of a system, but the inventive concept is not limited thereto.

The display apparatus 100 may display a video, still image, applications, on screen display (OSD), a graphic user interface (GUI) to control various operations, etc.

The input device 200 may be an external device which communicates with the display apparatus 100 using a wired connection, a wireless connection, over a network, etc. Alternatively, the input device 200 may be an internal device, such as a touch screen integrated with the display apparatus 100 or the touchpad of a notebook computer which includes the display apparatus 100. The input device 200 transmits commands to the display apparatus 100 corresponding to a user's manipulation.

The input device 200 generates various preset commands (for example, commands corresponding to a user's touch to the touch pad 210 of FIG. 1) and transmits the generated command to the display apparatus 100. The display apparatus 100 performs a control operation corresponding to a command that is transmitted by the input device 200.

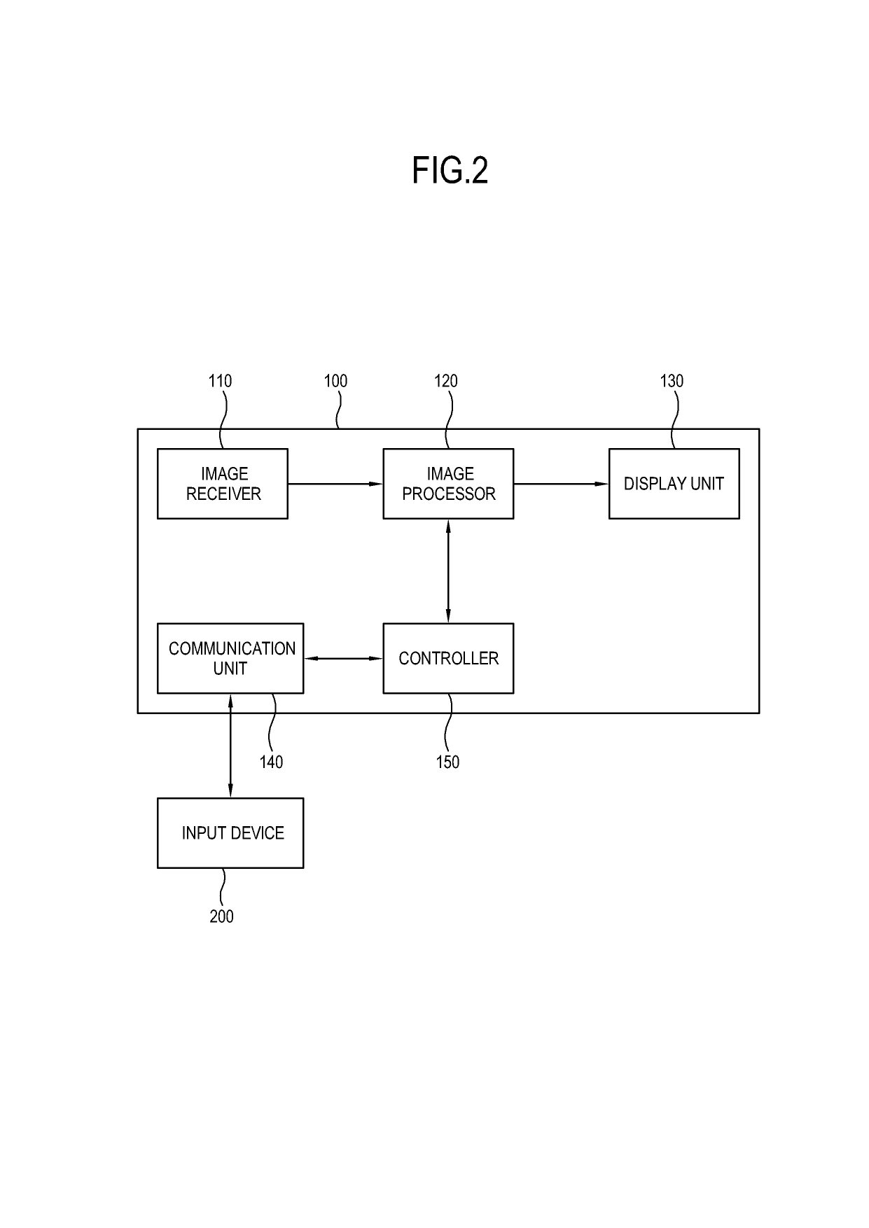

Hereinafter, a detailed configuration of the display apparatus 100 will be described with reference to FIG. 2. FIG. 2 is a block diagram of the display apparatus 100.

As shown therein, the display apparatus 100 includes an image receiver 110 which receives an image signal, an image processor 120 which process an image signal received by the image receiver 110, a display unit 130 which displays an image by using the image signal processed by the image processor 120, a communication unit 140 which communicates with the input device 200, and a controller 150 which controls general operations of the display apparatus 100. The image processor 120 and the controller 150 may be embodied as a hardware processor configure to execute operations.

The image receiver 110 receives an image signal from an image supply source (not shown) and transmits the image signal to the image processor 120. The image receiver 100 may receive the image signal using a wired connection, a wireless connection, over a network, etc. The image signal may be any type of image signal, including high definition multimedia interface (HDMI), DisplayPort, IEEE 1394 (“FireWire”), composite video, component video, S-Video, Digital Visual Interface, Video Graphics Array (VGA), etc, The image receiver 110 may also receive an image data packet stream from, for example, another device on the same network or from a streaming server (not shown).

The image processor 120 performs various image processing operations with respect to an image signal that is transmitted by the image receiver 110. The image processor 120 outputs the processed image signal to the display unit 130, on which an image is displayed based on the image signal.

The image processor 120 may perform various image processing operations including a decoding operation corresponding to an image format of an image signal, a de-interlacing operation to convert an interlace image signal into a progressive image signal, a scaling operation to adjust an image signal to a preset resolution, a noise reducing operation to improve an image quality, a detail enhancement and conversion of a frame refresh rate, but not limited thereto.

The image processor 120 may be a system-on-chip which integrates various functions or an image processing board (not shown) in which independent elements performing each of the foregoing operations are installed.

The display unit 130 displays an image thereon based on an image signal that is output by the image processor 120. The display unit 130 may include various displays such as a liquid crystal display, a plasma display panel, a light-emitting diode display, an organic light-emitting diode display, a surface-conduction electron-emitter display, a carbon nano-tube display, a nano-crystal display, but not limited thereto.

The display unit 130 may further include additional elements according to its embodiment. For example, if the display unit 130 includes liquid crystal, the display unit 130 includes a liquid crystal display panel (not shown), a backlight unit (not shown) emitting light to the liquid crystal display panel, and a panel driving substrate (not shown) driving the panel.

The communication unit 140 transmits commands/data/information/signals received from the input device 200 to the controller 150. The communication unit 140 may also transmit commands/data/information/signals received from the controller 150 to the input device 200. The communication unit 140 may communicate using a wireless connection (for example, using a wireless communication protocol such as radio frequency (RF), Zigbee, Bluetooth, etc.) a wired connection, over a network, etc.

The controller 150 controls an operation of the display apparatus 100 corresponding to commands received by the communication unit 140. For example, upon receiving a preset command from the input device 200 through the communication unit 140, the controller 150 controls the image processor 120 to perform an image processing operation corresponding to the command. According to the present exemplary embodiment, the controller 150 and the image processor 120 are provided as separate elements, but may otherwise be provided as a single image processing board (not shown).

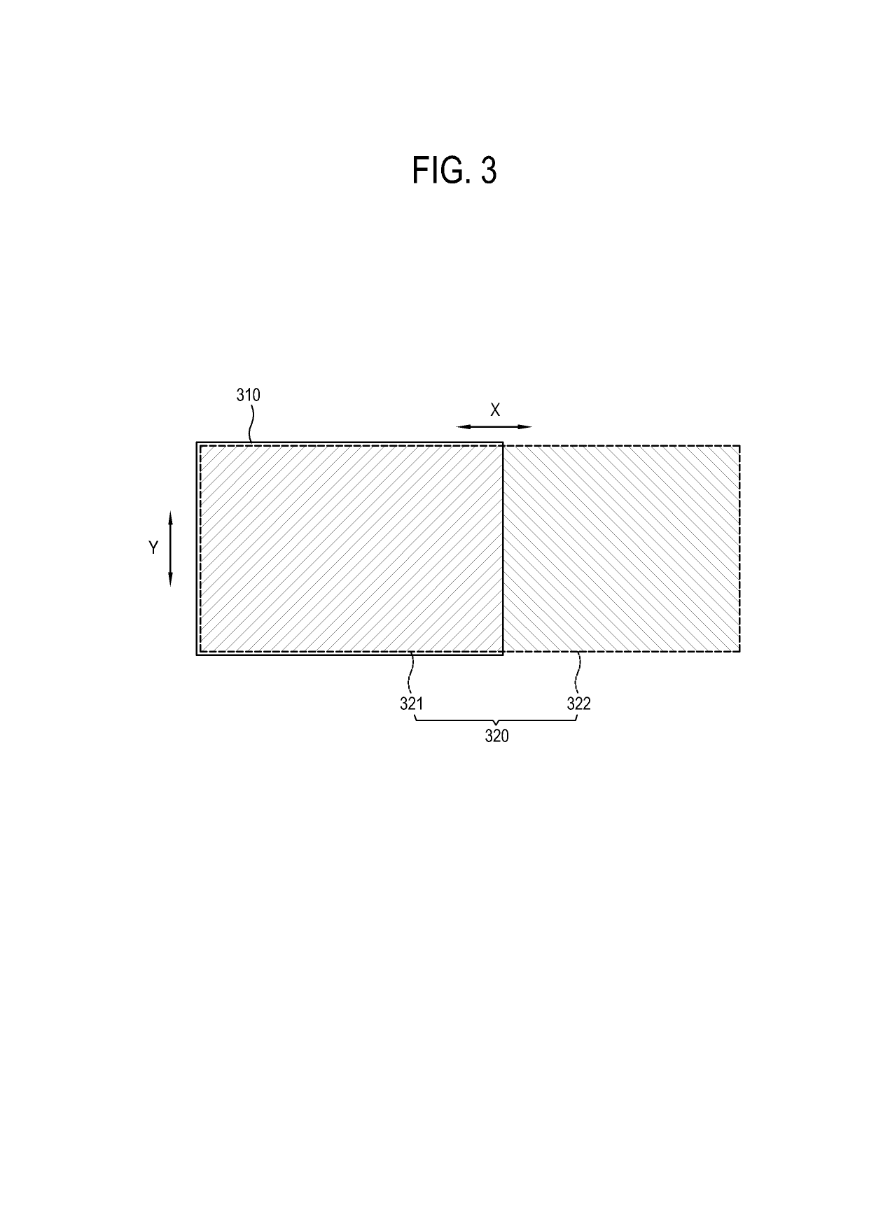

With the foregoing configuration, an example of displaying an image of a predetermined object 320 on the display unit 130 by the image processor 120 will be described with reference to FIG. 3. FIG. 3 illustrates an example of scrolling the object 320 that is displayed on the display unit 130.

According to the present exemplary embodiment, the object 320 generally refers to an object that is displayed as an image, but not limited to a certain type. For example, the object 320 may include a web page, a user interface (UI), etc. The object 320 may be divided into a plurality of parts (for example, a plurality of pages) or may linearly extend in a certain direction.

Alternatively, the image processor 120, the communication unit 140 and the controller 150 may be embodied in a computing device without an integrated display unit or image receiver. In such an instance, the image processor 120 may output an image signal to an external display unit using a wired or wireless connection, over a network, etc.

As shown in FIG. 3, a display area 310 is an area in which an image is displayed on the display unit 130. That is, in an entire area of the object 320, a first area 321 is an area that is currently displayed as an image. In the entire area of the object 320, a second area 322 which is outside of the display area 310 and is adjacent to the first area 321 is an area that is not currently displayed as an image.

To display the second area 322 of the object 320 as an image, object 320 must be moved until the second area 322 is inside of the display area 310. An operation of moving the object 320 to display the second area 322, which is not currently displayed, as an image is referred to as a scroll operation, and the aforementioned state of the object 320 is referred to as a scrollable state.

If a command is transmitted to the communication unit 140 by the input device 200 (manipulated by a user) to perform a scroll operation, the controller 150 controls the image processor 120 to perform a scroll operation so that the second area 322 is located within the display area 310.

With reference to FIG. 3, a transverse direction of the display area 310 will be referred to as an X direction and a vertical direction will be referred to as a Y direction. As shown therein, if a vertical height of the object 320 corresponds to a vertical height of the display area 310 and a transverse width of the object 320 is wider than a transverse width of the display area 310, the scroll operation for the object 320 is performed in the X direction.

If a vertical height of the object 320 is larger than the vertical height of the display area 310 and a transverse width of the object 320 corresponds to the transverse width of the display area 310, the scroll operation for the object 320 may be performed in the Y direction.

If both the transverse width and the vertical height of the object 320 are larger than the display area 310, the scroll operation for the object 320 may be performed in both the X direction and the Y direction. This may cause inconvenience for a user's manipulation.

With respect to an image of the object 320 that is displayed, a user may not easily recognize whether the object 320 is scrollable, depending on the content of the object 320.

For example, if the object 320 includes a plurality of icon images to execute various applications/functions/settings, a user may not easily recognize whether all icon images are displayed in the image of the object 320 that is currently displayed. That is, as the plurality of icon images is spaced from each other at a predetermined interval within the object 320, a user may not recognize that there is the second area 322 including other icon images since he/she views only the icon image in the first area 321 that is currently displayed.

In consideration of the foregoing, the display apparatus 100 according to the present exemplary embodiment may employ a following configuration.

If a preset command is received through the communication unit 140 while the first area 321 of the object 320 that is scrollable is displayed on the display unit 130, the controller 150 controls the image processor 120 to reduce the size of the object 320 in a scroll direction to display the first area 321 and at least a part of the second area 322 of the object 320 corresponding to the command.

Accordingly, a user may easily recognize that the currently-displayed object 320 is scrollable.

As the controller 150 reduces the size of the object 320 in the scroll direction, a user may easily recognize a direction in which the object 320 is scrollable.

For example, as in FIG. 3, based on the display area 310, the controller 150 reduces the size of the object at a preset rate in the X direction, and does not reduce the size of the object 320 in the Y direction. This indicates to the user that the object 320 is scrollable in the Y direction. Alternatively, if the object 320 is scrollable in the Y direction, the controller reduces the size of the object 320 in the Y direction to indicate to the user that the scroll direction of the object 320 is the Y direction.

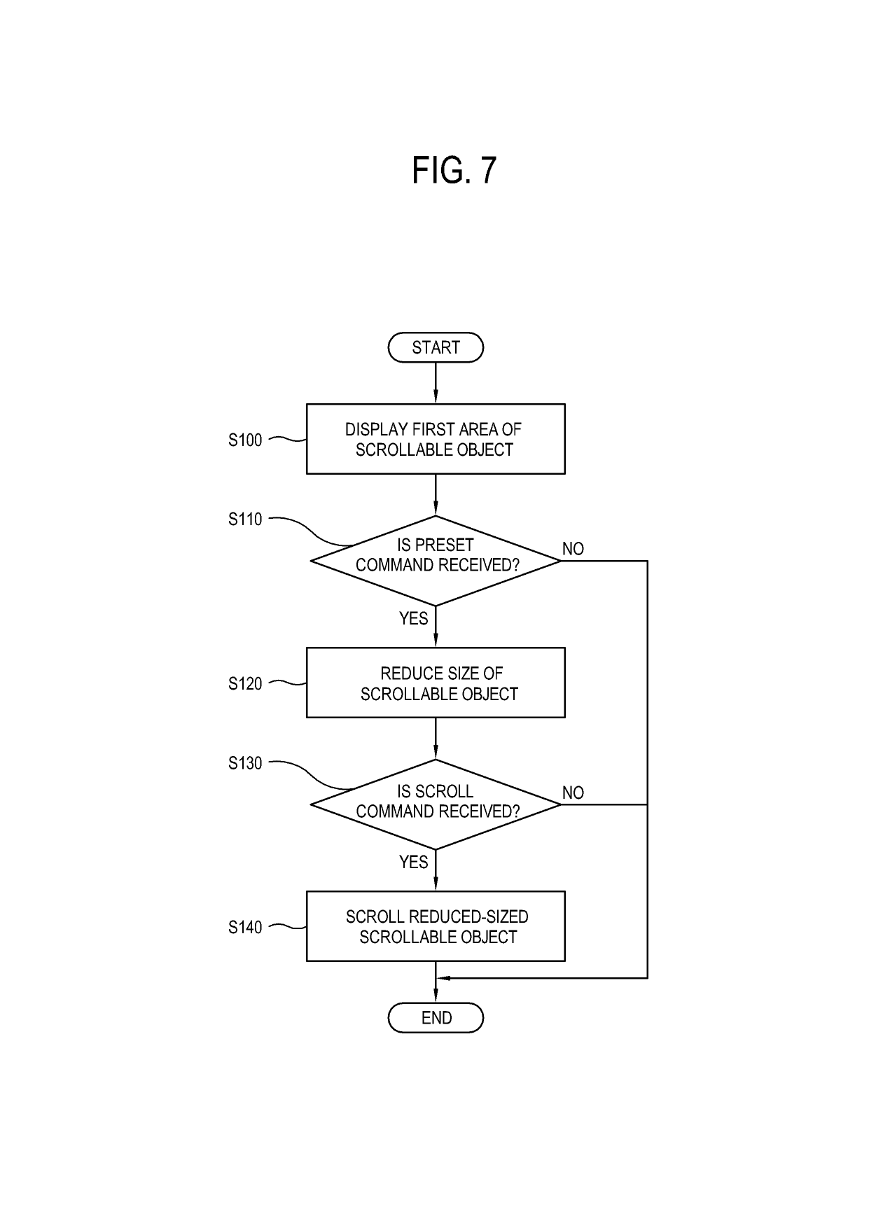

(As discussed below with reference to FIGS. 7 through 11, according other exemplary embodiments, the object may be reduced in size in all directions rather than only in the scrollable direction.)

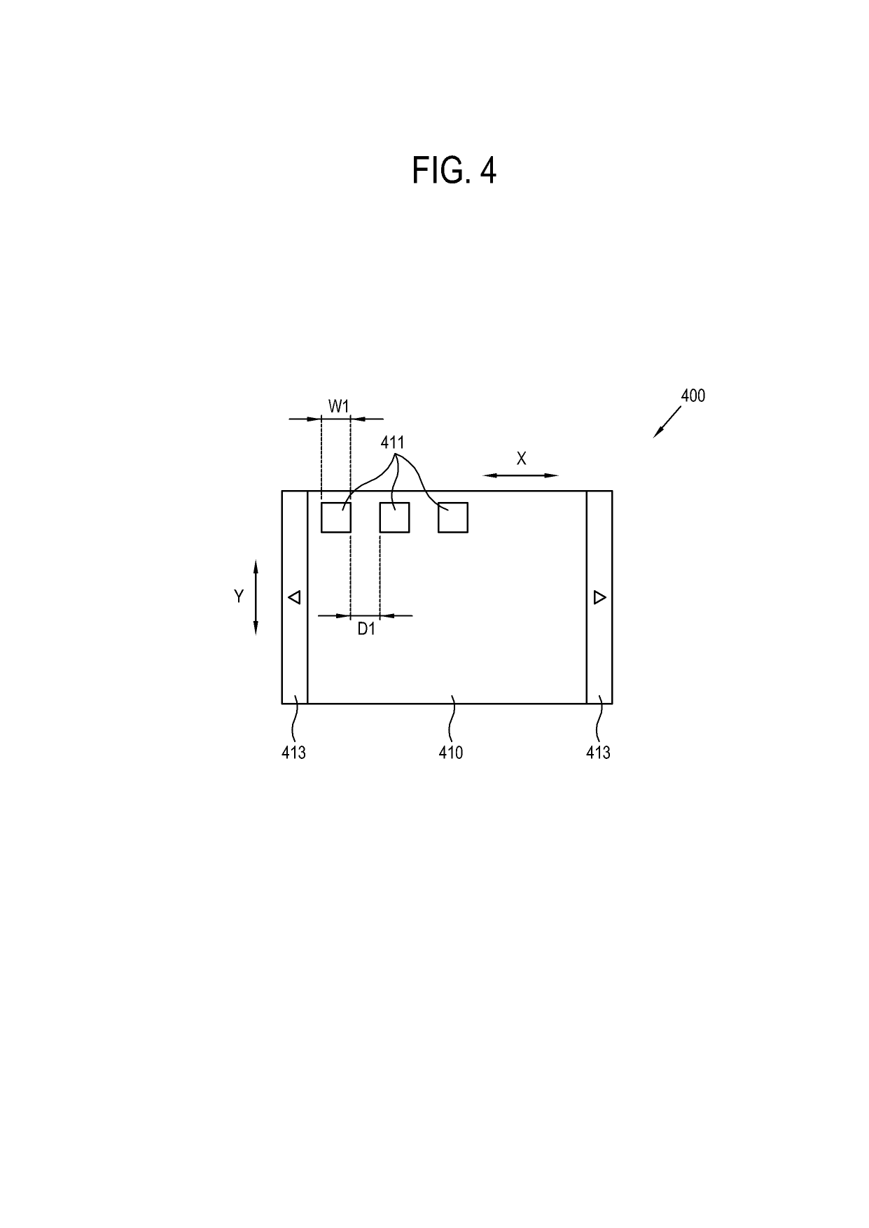

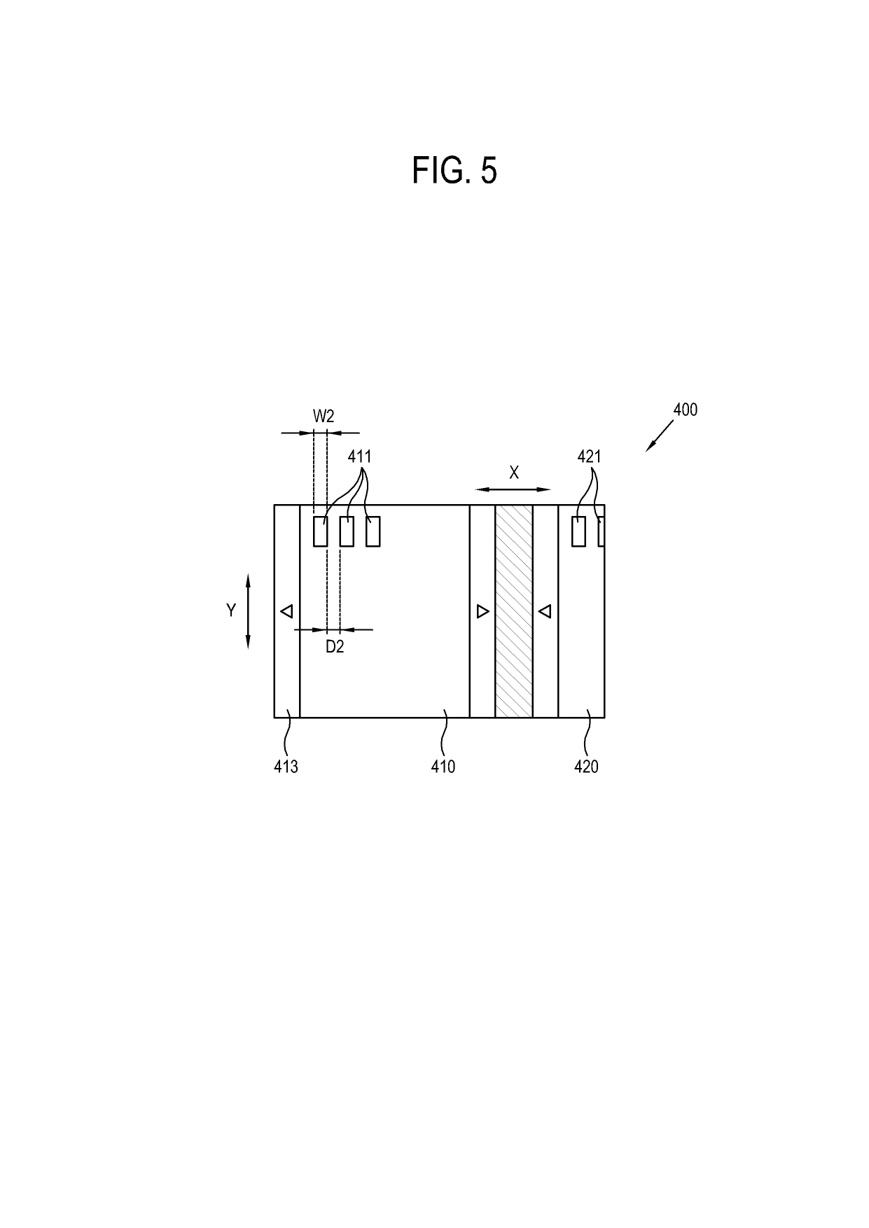

Hereinafter, an example of reducing and displaying a scrollable object 400 according to exemplary embodiments will be described with reference to FIGS. 4 and 5. FIG. 4 illustrates an example of an image of the object 400 in an initial state. FIG. 5 illustrates an example of an image of the object 400 that is reduced in size and displayed corresponding to a preset event.

The object 400 shown in FIGS. 4 and 5 includes a plurality of pages 410 and 420 which include a plurality of icon images 411 and 421, respectively. Such configuration of the object 400 is an exemplary embodiment, and does not limit the spirit of the inventive concept. The content and configuration of the object 400 may vary.

An area in which the object 400 is displayed on the display unit 130 may include an entire display area or a part of the display area of the display unit 130. The latter case may be realized if the configuration according to the present exemplary embodiment applies to one of the plurality of objects which are displayed together.

As shown in FIG. 4, the image processor 120 displays on the display unit 130 an image of a page 410 including a plurality of icon images 411, of the object 400. The image of the page 410 may include an additional scrolling object 413 which a user may select to scroll the object 400 in a scroll direction. A user, however, may not recognize the scrolling object 413. In this case, a user may not recognize whether the currently displayed object 400 is scrollable or its scroll direction is the X direction or the Y direction.

Then a user may manipulate the input device 200 to transmit a command to the display apparatus 100 from the input device 200. The configuration for generating the command by the input device 200 may vary. For example, the input device 200 may generate a particular command when a user is not in contact with a predetermined location of the touch pad 210 of the input device 200 for preset time after he/she has touched or tapped the predetermined location.

Otherwise, the input device 200 may generate a particular command if a user pushes a particular button among a plurality of buttons.

As shown in FIG. 5, the controller 150 reduces the size of the object 400 in the X direction upon receiving the command. The size reduction rate of the object 400 is determined corresponding to the received command. For example, such rate may be determined corresponding to the time during which a user is not in contact with the touch pad 210 of the input device 210 after the user has touched the touch pad 210 or the pushing time for the button of the input device 200. That is, the controller 150 reduces by stages the object 400 corresponding to the time during which the command is received.

As the object 400 is reduced in size and displayed, the page 420 of the object 400 and a part of the icon 421 included in the page 420 that were not visible in FIG. 4 are displayed. Then, a user may recognize that the object 400 is scrollable, via the image in FIG. 5.

The reduction in size of the object 400 is performed in the scroll direction. If the object 400 is scrollable in the X direction, the controller 150 reduces a width of the object 400 in the X direction instead of reducing the height of the object 400 in the Y direction that is perpendicular to the X direction.

As the object 400 is reduced in size, the width of the pages 410 and 420 and the icons 411 and 421 in the X direction are reduced in size. If the width of the image of the icon 411 in the page 410 is referred to as W1 and a distance between images of the two icons 411 that are adjacent to each other in the X direction in an initial state (refer to FIG. 4) is referred to as D1, the width W1 is reduced in size to W2 and the distance D1 is reduced in size to D2 at a preset reduction rate. The width W1 is wider than the width W2 and the distance D1 is longer than the distance D2. The ratio of the width W2 to the width W1 and the ratio of the distance D2 to the distance D1 correspond to the reduction rate.

A user may view the pages 410 and 420 reduced in size in the X direction and recognize that the object 400 is scrollable in the X direction. Then a user may manipulate the display apparatus 100 to perform a scroll operation in the X direction through the input device 200. For example, a user touches the touch pad 210 and moves his/her fingertip in the scroll direction to transmit the scroll movement command to the display apparatus 100 from the input device 200.

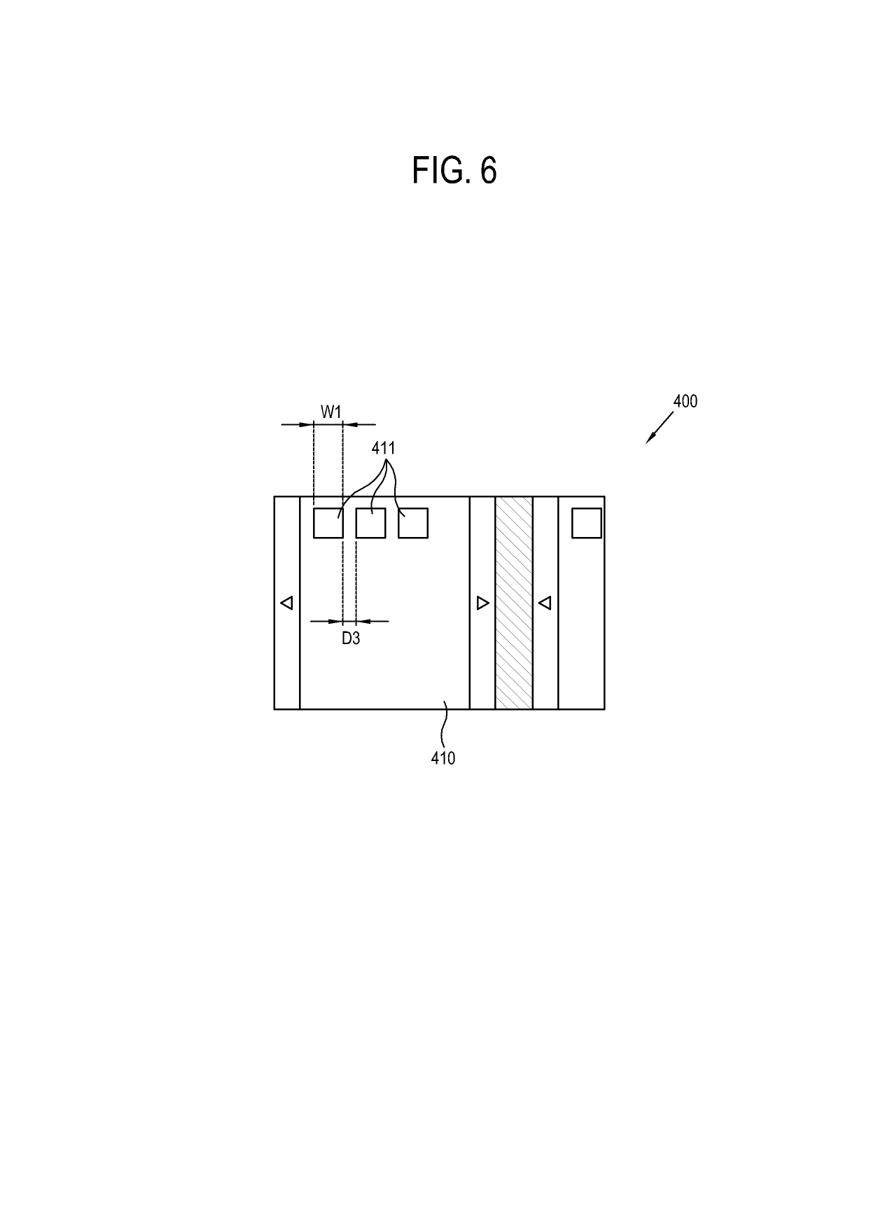

The reducing the size of the object is not limited to the example described with reference to FIG. 5. Other exemplary embodiments will be described with reference to FIG. 6.

As shown in FIG. 6, if a width of an image of an icon 411 in the page 410 is referred to as W1 and a distance between images of two icons 411 that are adjacent to each other in the X direction in the initial state (refer to FIG. 4) is referred to as D1, the controller 150 reduces the distance D1 to a distance D3 but does not adjust the width W1 of the images of the icons 411.

That is, if the object includes a plurality of sub-objects, the width of the entire object including the width and distance of the plurality of sub-objects may be reduced in size in the scroll direction or only the distance between the plurality of sub-objects may be reduced in size.

If an input that is input by the input device 200 through the communication unit 140 is not performed for preset time or a preset restoration command is received while the object has been reduced in size and displayed as in FIGS. 5 and 6, the controller 150 restores the object 400 to an original size and displays the restored object 400.

Hereinafter, a control method of the display apparatus 100 according to the present exemplary embodiment will be described with reference to FIG. 7. FIG. 7 is a flowchart of the control method of the display apparatus 100.

As shown therein, the display apparatus 100 displays a first area of a scrollable object (S100).

Upon receiving the preset command from the input device 200 (S110), the display apparatus 100 reduces the size of the object either in all dimensions or only in the dimension(s) which are scrollable (S120). If the display apparatus 100 reduces the size of the object in the dimension(s) which are scrollable, the display apparatus 100 reduces the width of the object that is in parallel with the scrollable direction and displays the reduced-sized object.

Upon receiving a scroll command from the input device 200 (S130), the display apparatus 100 scrolls the reduced-sized object in the scrollable direction (S140).

By the method described above, the display apparatus 100 may enable a user to recognize whether the object is scrollable and/or which direction is the scroll direction.

Alternatively, the method described above may be executed by a computing device without an integrated display unit. In such an instance, the computing device may output an image signal to an external display unit using a wired connection, a wireless connection, over a network, etc.

The above-described method may also be embodied in a computer-executable program stored on a computer-readable storage medium. A computer-readable storage medium may be is any data storage device that can store data that can be thereafter read by a computer system. Examples of the computer-readable storage medium include read-only memory (ROM), random-access memory (RAM), CD-ROMs, magnetic tapes, floppy disks, and optical data storage devices. The computer-readable storage medium can also be distributed over network-coupled computer systems so that the computer-readable code is stored and executed in a distributed fashion. The computer-executable program may be executed using a processor or microprocessor.

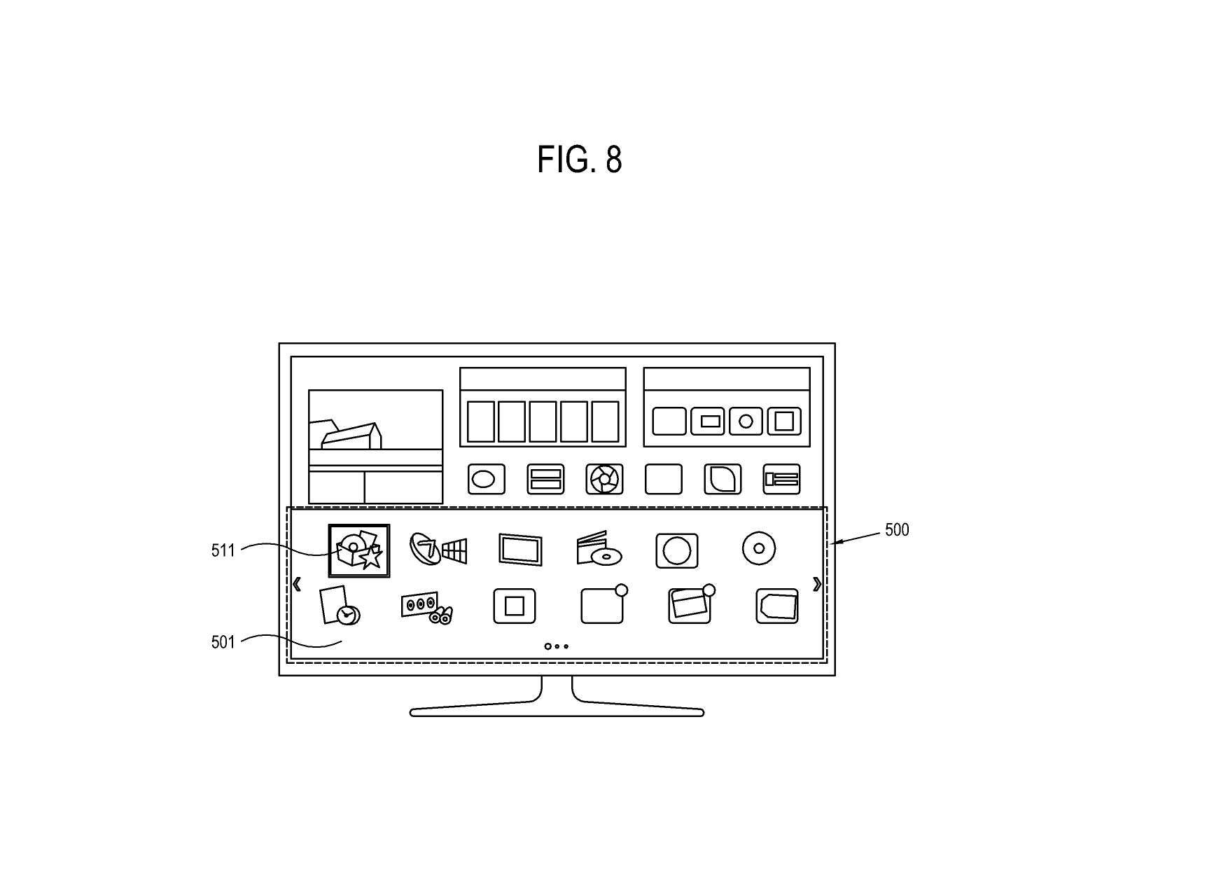

Other exemplary embodiments will be described with reference to FIGS. 8 to 12.

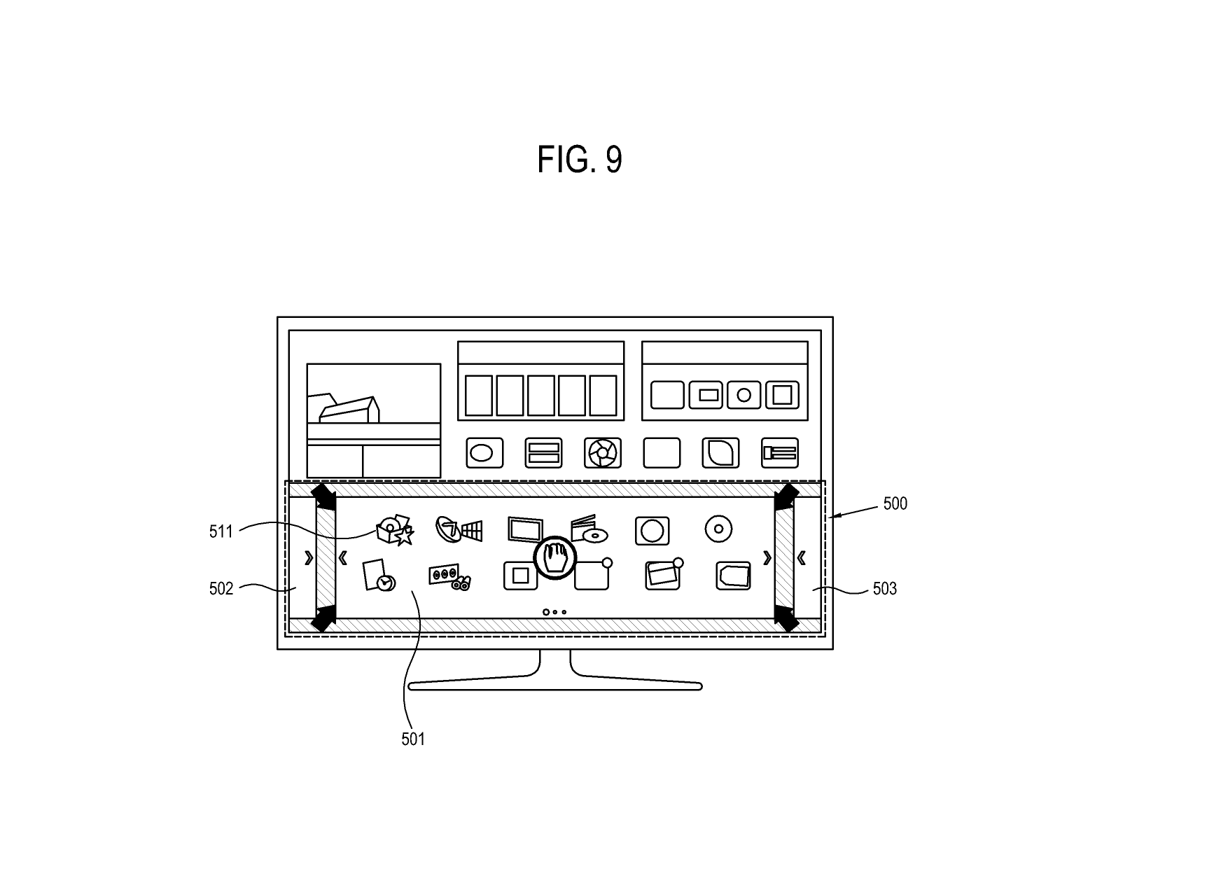

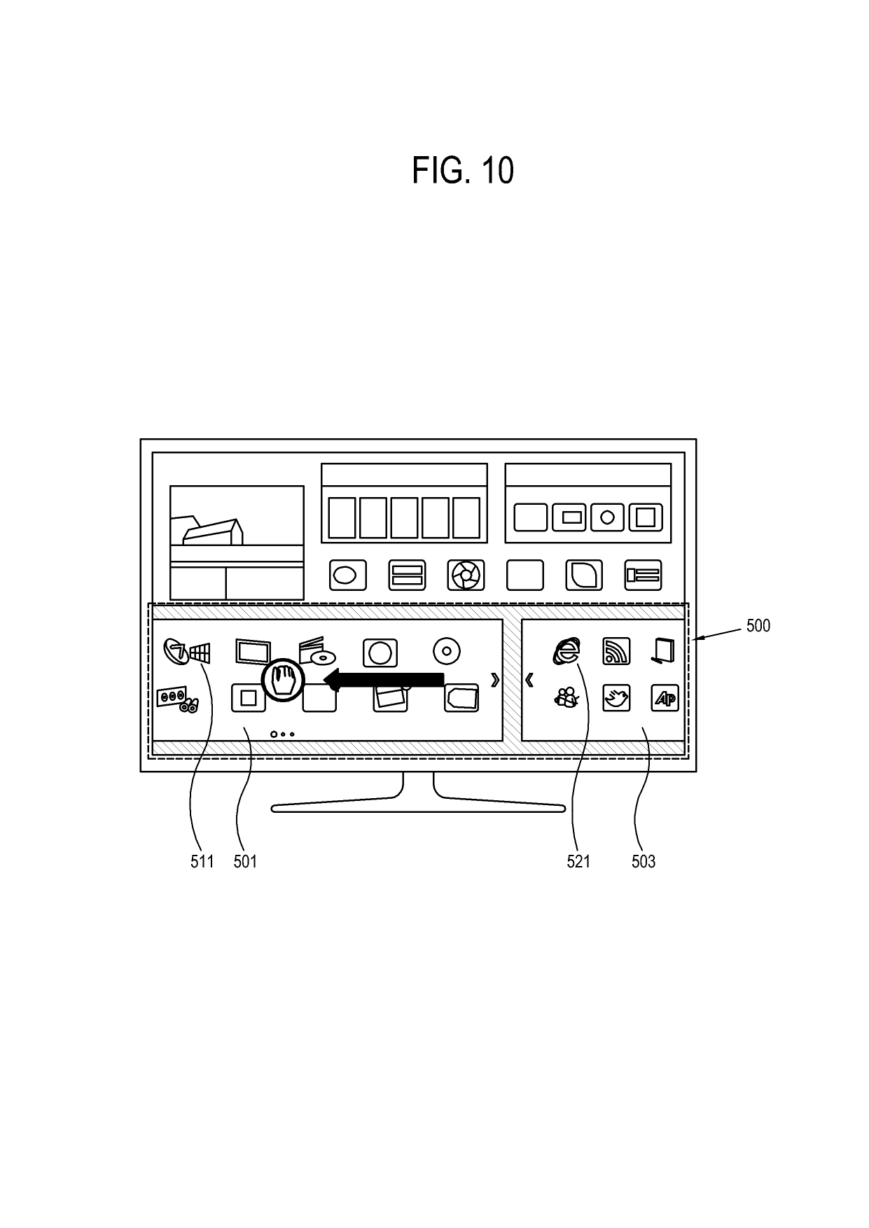

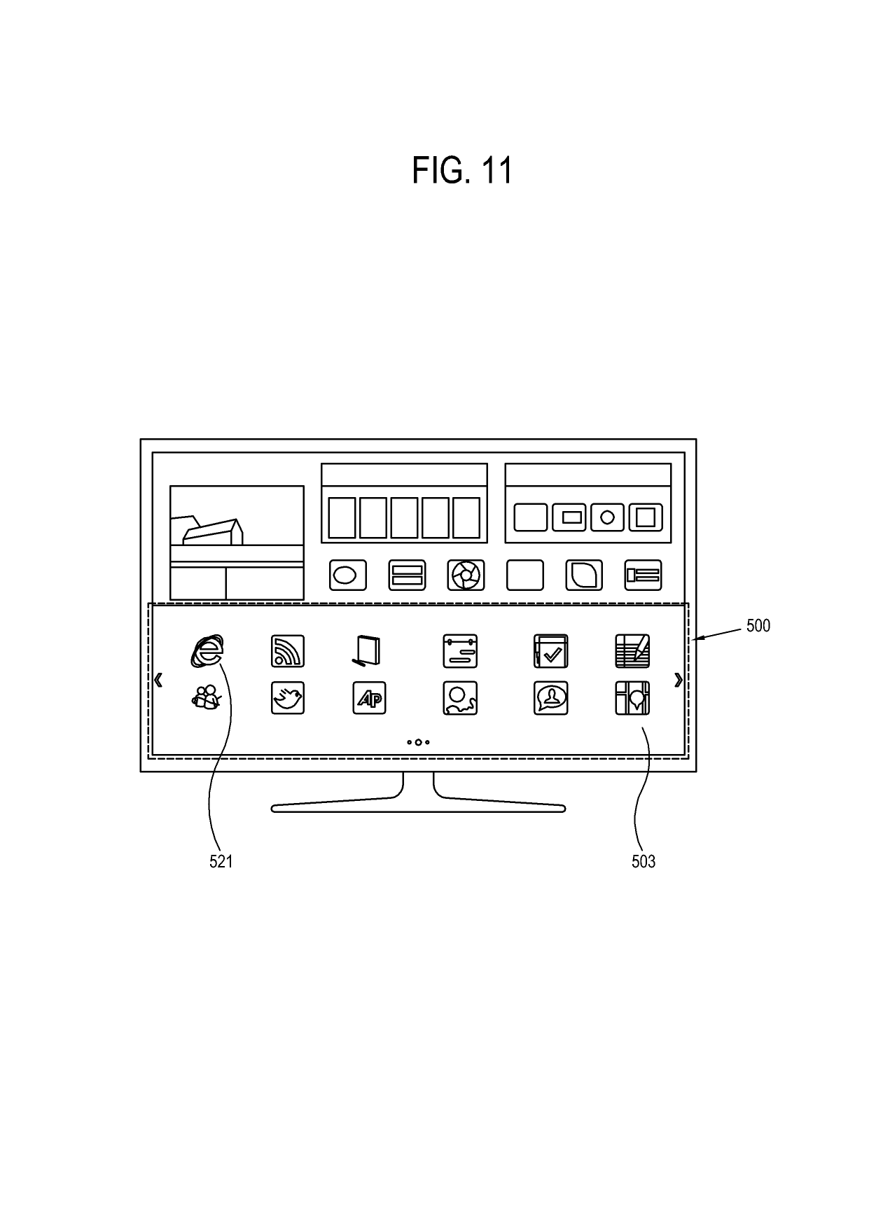

FIG. 8 illustrates an example of a user interface (UI) screen 500 in an initial state in a display apparatus 100 according to exemplary embodiments. FIG. 9 illustrates an example of a UI screen 500 that has been reduced in size from the state in FIG. 8. FIG. 10 illustrates an example of a UI screen 500 that is scrollable. FIG. 11 illustrates an example of a UI screen 500 that has been restored to its original size from the state in FIG. 10.

The image processor 120 may display the UI screen 500 in the entire displayable area on the display unit 130 or a portion of the displayable area on the display unit 130. As shown in FIG. 8, the image processor 120 divides the displayable area of the display unit 130 into upper and lower parts and displays the UI screen 500 in the lower part.

The image processor 120 may divide the displayable area on the display unit 130 into any number of areas and may display different UI screens 500 in the plurality of areas. The controller 150 may individually/independently scroll the UI screen 500 for each area.

The UI screen 500 according to an exemplary embodiment may include a plurality of objects, including the object 511, which may be realized as items or icons. The plurality of objects may be formed into a plurality of groups, and the UI screen 500 may be formed as a plurality of pages including the objects of each group.

In FIG. 8, the UI screen 500 of a page 501 which includes the object 511 of a first group out of the plurality of objects is displayed.

A user may perform an input operation through the input device 200. For example, the user may click the area in which the object 511 is not displayed on the UI screen 500. Then, the input device 200 transmits a command for starting scroll of the screen to the display apparatus 100.

As shown in FIG. 9, if the command for starting scroll of the screen is input through the input device 200, the controller 150 reduces the size of the UI screen 500. The controller 150 may reduce the size of the UI screen 500 only in the direction in which the UI screen 500 is scrollable or, as shown in FIG. 9, the controller 150 may reduce the size of the UI screen 500 in all directions.

As the UI screen 500 is reduced in size, pages 502 and 503 of the UI screen 500 which have not been displayed in the initial state in FIG. 8, other than the page 501 including the object 511 of the first group displayed in the initial state in FIG. 8, are partially displayed. Then, a user may determine that the UI screen 500 is scrollable and in which direction the UI screen is scrollable.

While the UI screen 500 is reduced in size, a user may perform a preset input operation through the input device 200. For example, the user may designate a predetermined direction by clicking a direction key (not shown) or by touching and dragging a touch pad (not shown). Then, the input device 200 transmits to the display apparatus 100 a command for scrolling the screen including a direction in which the user wishes to scroll.

As shown in FIG. 10, the controller 150 scrolls the UI screen 500 that has been reduced and displayed, in a direction corresponding to a command that has been transmitted by the input device 200 to scroll the screen.

The UI screen 500 includes a first group of objects, including the object 511, displayed as part of the page 501, and a second group of objects, including an object 521, displayed as part of the page 503. As the UI screen 500 is scrolled, the page 503, including the object 521, is displayed. UI screen 500 including The objects displayed as part of the page 501 are different from the objects displayed as part of the page 503.

The page 503, including the object 521 of the second group, is reduced in size and displayed at the same rate as the page 501, including the object 511 of the first group.

Then, the controller 150 may determine whether the input of the command for the scroll of the screen has ended. The ending of inputting of the scroll command may vary. For example, the controller 150 may determine that the input of the command has ended if there is no user input through the input device 200 for predetermined time after the scroll command has been input, if the input for selecting one of the objects, such as the object 511 or the object 521, has been performed through the input device 200 or the input for ending the scroll has been performed through the input device 200.

As shown in FIG. 11, the controller 150 restores the UI screen 500 including the object 521 of the second group of the page 503 to its original size if it is determined that the input of the scroll command has been ended. That is, the controller 150 increases the size of the UI screen 500 including the object 521 of the second group to the same size as the original size of the UI screen 500 including the object 511 of the first group of the page 501.

The above-described exemplary embodiments may also be embodied in a graphical user interface for an electronic device which includes an image processor and a display unit.

Although a few exemplary embodiments have been shown and described, it will be appreciated by those skilled in the art that changes may be made in these exemplary embodiments without departing from the principles and spirit of the inventive concept, the range of which is defined in the appended claims and their equivalents.

What is claimed is:

1. A display apparatus comprising:
a display unit;
an image processor which generates a user interface (UI) screen and displays the UI screen on the display unit; and
a controller which controls the image processor to display on the display unit the UI screen comprising an object of a first group of objects, to reduce a size of the UI screen displayed on the display unit in response to a first command, and to scroll the UI screen comprising an object of a second group in response to a command to scroll the UI screen.

2. The display apparatus according to claim 1, wherein the controller controls the image processor to display the UI screen comprising the object of the first group and at least a part of the object of the second group.

3. The display apparatus according to claim 1, wherein the UI screen comprising the object of the first group and the UI screen comprising the object of the second group are reduced in size at a same rate.

4. The display apparatus according to claim 3, wherein in response to a command to discontinue scrolling the UI screen, the UI screen comprising the object of the second group is enlarged and displayed in the same size as the original size of the UI screen comprising the object of the first group.

5. The display apparatus according to claim 4, wherein the command to discontinue scrolling the UI screen comprises at least one of a user input to discontinue scrolling the UI screen, absence of a user input for predetermined time after the first command is received, and a command selecting one of the objects in the UI screen.

6. The display apparatus according to claim 1, wherein the first command comprises a user selection of an area of the UI screen in which an object is not displayed, and the command to scroll the UI screen comprises a user input indicating a scrolling direction.

7. The display apparatus according to claim 1, wherein the image processor displays a plurality of UI screens and the controller independently scrolls each of the plurality of UI screens.

8. A control method of a display apparatus, the control method comprising:
displaying on a display unit a user interface (UI) screen comprising an object of a first group of objects;
reducing a size of the UI screen in response to a first command; and
displaying on the display unit the UI screen comprising an object of a second group of objects in response to a command to scroll the UI screen.

9. The control method according to claim 8, wherein the reducing the size of the UI screen comprises displaying the UI screen comprising the object of the first group and at least a part of the object of the second group.

10. The control method according to claim 8, wherein the UI screen comprising the object of the first group and the UI screen comprising the object of the second group are reduced in size at a same rate.

11. The control method according to claim 10, wherein in response to a command to discontinue scrolling the UI screen, the UI screen comprising the object of the second group is enlarged and displayed in the same size as the original size of the UI screen comprising the object of the first group.

12. The control method according to claim 11, wherein the command to discontinue scrolling the UI screen comprises at least one of a user input to discontinue scrolling the UI screen, absence of a user input for a predetermined time after the first command is received, and a command selecting one of the objects in the UI screen.

13. The control method according to claim 8, wherein the first command comprises a user selection of an area of the UI screen in which an object is not displayed, and the command to scroll the UI screen comprises a user input indicating a scrolling direction.

14. A graphical user interface for an electronic device comprising an image processor, and a display unit, the graphical user interface comprising:
a scrollable user interface area of a predetermined size on a screen of the display unit, wherein:
in response to detecting a first user input, a size of the user interface area is reduced,
in response to detecting a second user input, the user interface area is scrolled, and
in response to the user interface area no longer being scrolled, the size of the user interface area is increased to the predetermined size.

15. The graphical user interface of claim 14, wherein the user interface area is no longer scrolled in response to at least one of a user input to stop scrolling, absence of a user input for a predetermined time after the first user input is received, and a selection of a user interface object included in the user interface area.

16. The graphical user interface of claim 14, wherein the user interface area is scrollable in a first dimension and not scrollable in a second dimension.

17. The graphical user interface of claim 16, wherein the reducing the size of the user interface area comprises reducing the size of the user interface area in the first dimension and not reducing the size of the user interface area in the second dimension.

18. The graphical user interface of claim 16, wherein the reducing the size of the user interface area comprises reducing the size of the user interface area in the first dimension and in the second dimension.

19. The graphical user interface of claim 14, wherein:
the user interface area comprises a plurality of user interface objects, and
the reducing the size of the user interface area comprises reducing a distance between the plurality of user interface objects.

20. The graphical user interface of claim 14, wherein:
the user interface area comprises a plurality of user interface objects, and
the reducing the size of the user interface area comprises reducing a distance between the user interface objects and reducing the size of the user interface objects.

21. The graphical user interface of claim 14, wherein:
the user interface area comprises a plurality of pages,
a first page of the plurality of pages is visible when the user interface area is of the predetermined size,
a second page of the plurality of pages is not visible when the user interface area is of the predetermined size, and
the reducing the size of the user interface area comprises reducing the size of the first page and the second page and at least partially displaying the second page.

22. The graphical user interface of claim 14, wherein:
the user interface area comprises a plurality of groups of user interface objects,
a first group of user interface objects is visible when the user interface area is of the predetermined size,
a second group of user interface objects is not visible when the user interface area is of the predetermined size, and
the reducing the size of the user interface area comprises reducing the size of the user interface area and at least partially displaying the second group of user interface objects.
